(19) United States
(12) Patent Application Publication
(10) Pub. No.: US 2024/0071673 A1
(43) Pub. Date: Feb. 29, 2024

(54) COIL COMPONENT, CIRCUIT BOARD, AND ELECTRONIC DEVICE

(71) Applicant: Taiyo Yuden Co., Ltd., Tokyo (JP)

(72) Inventors: Yasuhiro Arai, TOKYO (JP); Toshimasa Suzuki, TOKYO (JP)

(21) Appl. No.: 18/456,776

(22) Filed: Aug. 28, 2023

(30) Foreign Application Priority Data
Aug. 31, 2022 (JP) 2022-137751

(51) Int. Cl. H01F 27/02; H01F 27/29

(52) U.S. Cl. CPC H01F 27/027; H01F 27/292

(57) ABSTRACT

Disclosed herein is a coil component including a base body having a magnetic body portion containing a metal magnetic material, a conductor provided inside the base body, an insulating layer that is provided on a surface of the magnetic body portion in the base body and that is a resin containing carbon particles, and an external electrode that extends along the surface of the base body and that is connected to the conductor.

### CROSS REFERENCE TO RELATED APPLICATIONS

This application claims priority benefit of Japanese Patent Application No. JP 2022-137751 filed in the Japan Patent Office on Aug. 31, 2022. Each of the above-referenced applications is hereby incorporated herein by reference in its entirety.

### BACKGROUND

The present disclosure relates to a coil component, a circuit board, and an electronic device.

Mobile phones are a typical example of high-performance electronic devices. Electronic components used in mobile phones are required not only to have high performance but also to be small in size. One example of the electronic components is a coil component. There are various types of coil components, some of which contain magnetic materials, some of which contain non-magnetic materials, and some of which contain a combination of both.

Further, among coil components containing magnetic materials, there are coil components with a magnetic material sintered and coil components with a magnetic material and a resin mixed. In particular, coil components containing a material with a metal magnetic material and a resin mixed are rapidly becoming smaller in size, and devices and applications in which coil components are used are also expanding.

While coil components need to meet the requirements for higher performance and miniaturization, they also need to meet some basic requirements, one of which is to secure the insulating property. For example, in the case where a metal magnetic material is used, a magnetic body is made by combining the metal magnetic material and an insulator, so that a magnetic body with the insulating property is produced. In order to secure the insulating property, the reliability of the insulation is required rather than the size of the insulation.

For example, PCT Patent Publication No. WO2016/117201 (hereinafter referred to as “Patent Document 1”) discloses a technique of covering the surface of a dust core with an insulation coat. This is because the core loss of the dust core may change in a high temperature environment. In other words, a change in core loss can lead to the degradation of insulation during exposure to a high temperature environment. For this reason, the insulation coat is used to stabilize the insulation of the dust core.

A coil component of another type that differs from the dust core type is of a metal composite type in which a coil is encased in a composite magnetic material containing a metal magnetic material and a resin. The coil component of this type is also required to secure the insulation. In the case where a high pressure is applied to increase the filling rate of the metal magnetic material, such an insulation coat as described in Patent Document 1 may be provided to secure the insulation.

### SUMMARY

The voltage resistance of coil components containing metal magnetic materials is low, and when a high voltage is applied to such coil components, electrical breakdown is likely to occur in the metal magnetic materials. Therefore, a coil component containing a metal magnetic material is, in some cases, provided with an insulation coat.

In this case, in order to secure the voltage resistance property with the insulation coat, a component needs to be covered entirely and completely so as not to cause any defects. Therefore, the insulation coat is provided in such a manner as to have a very large thickness. This, however, makes it difficult to cope with the component size limitation and miniaturization. As a result, the coil component is used under certain restrictions.

Moreover, while the insulation coat increases the insulation of the coil component, the insulation coat also makes the coil component more easily charged due to friction and other factors. Therefore, measures against static electricity are also important in the process of manufacturing the coil component and in the handling of the coil component.

In view of the foregoing, it is desirable to secure the insulating property while suppressing charging.

According to an embodiment of the present disclosure, there is provided a coil component including a base body having a magnetic body portion containing a metal magnetic material, a conductor provided inside the base body, an insulating layer that is provided on a surface of the magnetic body portion in the base body and that is a resin containing carbon particles, and an external electrode that extends along the surface of the base body and that is connected to the conductor.

In the coil component according to the embodiment of the present disclosure, the insulating layer contains the carbon particles in an amount of higher than 0.01 vol %.

Further, in the coil component according to the embodiment of the present disclosure, the insulating layer contains an insulating inorganic filler.

In the coil component according to the embodiment of the present disclosure, the insulating layer contains, as the inorganic filler, a first inorganic filler having a major axis and a minor axis.

Further, in the coil component according to the embodiment of the present disclosure, the insulating layer contains, as the inorganic filler, a second inorganic filler having a spherical shape.

In the coil component according to the embodiment of the present disclosure, the resin has a glass transition temperature of higher than 150° C.

Further, in the coil component according to the embodiment of the present disclosure, the base body has a first surface and a second surface opposite to the first surface, the insulating layer is provided on the first surface, and the external electrode is provided on the second surface.

In the coil component according to the embodiment of the present disclosure, the insulating layer covers the entire first surface.

Further, in the coil component according to the embodiment of the present disclosure, the insulating layer extends from the first surface to a surface adjacent to the first surface.

In the coil component according to the embodiment of the present disclosure, the external electrode extends from the second surface to a surface adjacent to the second surface.

Further, in the coil component according to the embodiment of the present disclosure, the insulating layer has a thickness of less than 10 μm.

According to another embodiment of the present disclosure, there is provided a circuit board including the coil component described above and a substrate on which the coil component is mounted.

According to a further embodiment of the present disclosure, there is provided an electronic device including the circuit board described above.

According to the present disclosure, it is possible to secure the insulating property while suppressing charging.

### BRIEF DESCRIPTION OF THE DRAWINGS

FIG. 1 is a perspective view of a coil component according to a first embodiment of the present disclosure;

FIG. 2 is a side view of the coil component illustrated in FIG. 1;

FIG. 3 is a cross-sectional view of the coil component illustrated in FIG. 1;

FIG. 4 is an enlarged view conceptually illustrating a microscopic structure in an insulating layer;

FIG. 5 is a view of aggregates in a resin component;

FIG. 6 is a flowchart illustrating an example of a method of manufacturing the coil component;

FIG. 7 is a flowchart illustrating another example of the method of manufacturing the coil component;

FIG. 8 is a cross-sectional view of a coil component according to a second embodiment;

FIG. 9 is a flowchart illustrating a method of manufacturing the coil component according to the second embodiment;

FIG. 10 is a cross-sectional view of a coil component according to a third embodiment;

FIG. 11 is a flowchart illustrating a method of manufacturing the coil component according to the third embodiment;

FIG. 12 is a cross-sectional view of a coil component according to a fourth embodiment;

FIG. 13 is a flowchart illustrating a method of manufacturing the coil component according to the fourth embodiment; and

FIG. 14 is a cross-sectional view of a coil component according to a fifth embodiment.

### DETAILED DESCRIPTION OF THE PREFERRED EMBODIMENTS

Embodiments of the present disclosure are described in detail below with reference to the accompanying drawings. The following embodiments do not limit the scope of the present disclosure. Not all combinations of features described in the embodiments are essential to the configurations of the present disclosure. The configurations of the embodiments may be modified or changed as appropriate depending on the specifications of the device to which the present disclosure is applied and various conditions (usage conditions, usage environments, etc.).

The technical scope of the present disclosure is defined by the claims and is not limited by the following individual embodiments. In order to make each configuration easier to understand, the drawings used in conjunction with the following description may differ in scale and shape from the actual structure. Constituent elements illustrated in the drawings previously described may be referred to as appropriate in the description of the subsequent drawings.

### First Embodiment

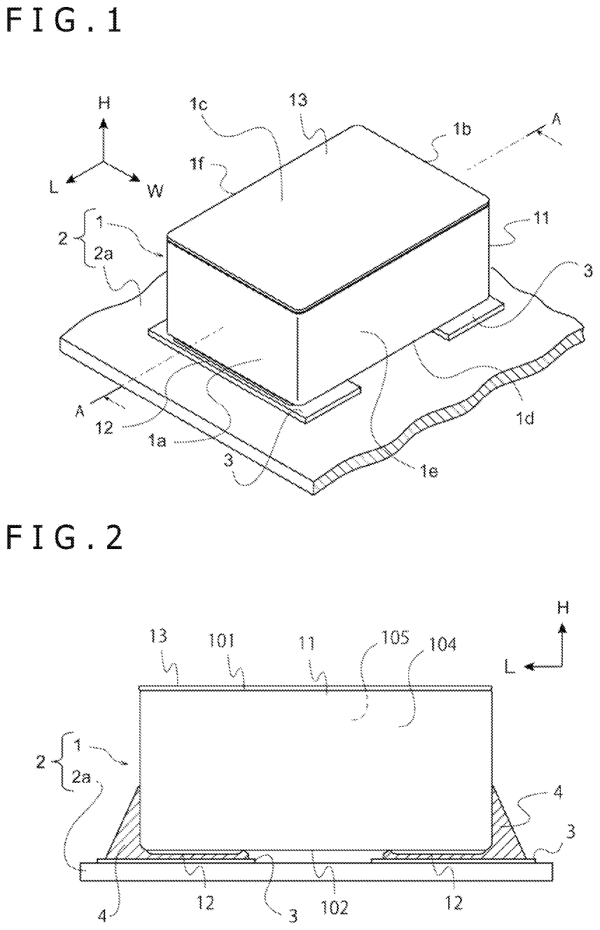

FIG. 1 is a perspective view of a coil component according to a first embodiment of the present disclosure.

A coil component 1 is mounted on a substrate 2a. The substrate 2a has, for example, two land portions 3. The coil component 1 includes one base body 11 and two external electrodes 12. The coil component 1 is mounted on the substrate 2a with the external electrodes 12 soldered to the respective land portions 3. A circuit board 2 according to one embodiment of the present disclosure includes the coil component 1 and the substrate 2a on which the coil component 1 is mounted. The circuit board 2 can be mounted in various electronic devices. Examples of the electronic devices in which the circuit board 2 can be mounted include electrical components of automobiles, servers, board computers, and various other electronic devices.

In the present specification, unless otherwise construed from the context, the description of directions is based on an “L-axis” direction, a “W-axis” direction, and an “H-axis” direction of FIG. 1. The “L-axis” direction, the “W-axis” direction, and the “H-axis” direction are referred to as the “length” direction, the “width” direction, and the “height” direction, respectively. The “height” direction may also be referred to as the “thickness” direction.

The coil component 1 has a rectangular parallelepiped outer shape. That is, the coil component 1 has a first end surface 1a and a second end surface 1b at respective ends in the length direction L, a first main surface 1c (top surface 1c) and a second main surface 1d (bottom surface 1d) at respective ends in the height direction H, and a front surface 1e and a rear surface 1f at respective ends in the width direction W.

The dimension of each side of the coil component 1 in the shape of a rectangular parallelepiped is, for example, in the range of 1 to 5 mm in the length direction L, 0.5 to 3.5 mm in the width direction W, and 0.5 to 2.5 mm in the height direction H. Further, the dimension in the height direction H is smaller than the dimension in the length direction L, and the dimension in the height direction H is smaller than the dimension in the width direction W.

The first end surface 1a, second end surface 1b, first main surface 1c, second main surface 1d, front surface 1e, and rear surface 1f of the coil component 1 may all be flat or curved surfaces. The eight corners and twelve ridges of the coil component 1 may be rounded.

In the present specification, even in the case where part of the first end surface 1a, second end surface 1b, first main surface 1c, second main surface 1d, front surface 1e, and rear surface 1f of the coil component 1 is curved or a corner or ridge of the coil component 1 is rounded, the coil component 1 may be described as having a “rectangular parallelepiped” shape. In other words, in the case where “rectangular parallelepiped” or “rectangular parallelepiped shape” is described in the present specification, it does not indicate “rectangular parallelepiped” in a rigorous mathematical sense.

### Structure of Coil Component

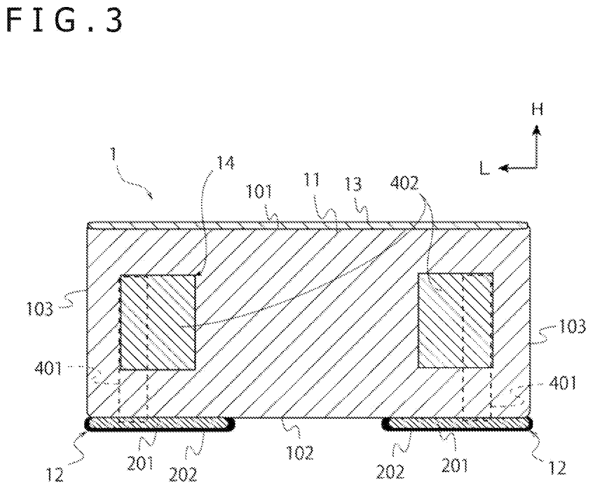

FIG. 2 is a side view of the coil component 1 illustrated in FIG. 1. FIG. 3 is a cross-sectional view of the coil component 1 illustrated in FIG. 1. Specifically, FIG. 3 illustrates a cross-section taken along a line A-A illustrated in FIG. 1. The following description is made with reference to FIGS. 1 to 3.

The coil component 1 according to the first embodiment of the present disclosure includes the base body 11, the external electrodes 12, and an insulating layer 13. Further, the coil component 1 includes a conductor 14 provided inside the base body 11. Here, the base body 11 may be a magnetic body including therein a conductor or may be a combination of a magnetic body which is called a T core or a drum core and which has a brim and a shaft around which the conductor is wound on its surface, and an outer body covering the conductor.

The base body 11 according to the present embodiment is a magnetic body including a metal magnetic material and a binder and does not have an outer body in the example of FIG. 3. The binder bonds particles of the metal magnetic material and is a high insulating material to prevent electrical conduction. The binder used for the base body 11 is a binder with which the specific resistance of the magnetic base body is 10⁶ Ωcm or higher. For example, a binder with a specific resistance of 10⁸ Ωcm or higher is selected, and for the purpose of increasing the mechanical strength, a resin, glass, or metal oxide may be selected as the binder.

For example, a resin having a glass transition temperature (Tg) of higher than 150° C. is selected as the resin of the binder, and a resin having a Tg of higher than 180° C. may be selected. A resin with such a high Tg can cope with environmental changes in high temperature applications as with glass and metal oxide.

The base body 11 has a significantly high internal specific resistance, which is also true on its surface. Further, the binder is also present on the surface of the base body 11. The metal magnetic material contains one or more metal magnetic particles among Fe, Ni, and Co. In addition to the metal magnetic particles, the metal magnetic material may also contain one or more ceramic magnetic particles among Mg, Mn, and Ni and nonmagnetic particles such as silica. The metal magnetic particles may contain one or more components among Si, Cr, Al, B, and P in addition to the Fe, Ni, and/or Co components or may be a combination of a plurality of types of metal magnetic particles.

The metal magnetic particles have a particle diameter of 1 to 30 μm on average and have a particle diameter in the range of 0.1 to 50 μm including a particle diameter distribution. The metal magnetic particles may be insulated, or insulation may be secured by the presence of the resin.

In the case where the metal magnetic material further contains other materials such as metal microparticles, metal oxide, and a ceramic material in addition to the metal magnetic particles, the particle diameters of the other materials are 0.01 to 1 μm on average, which is smaller in particle diameter than the metal magnetic particles. In the case where the metal magnetic material contains materials other than the metal magnetic particles, they can, for example, reduce voids or help improve the mechanical strength rather than enhancing the function as magnetism.

In the magnetic body forming the base body 11, the ratio of the magnetic material to the volume of the magnetic body is 85 vol % or higher, preferably 88 vol % or higher, and the remainder of the magnetic body is other than the metal magnetic material and contains insulators or voids.

The base body 11 has a rectangular parallelepiped shape and has a top surface 101 at one end in the height direction H, a bottom surface 102 at the other end in the height direction H, an end surface 103 at each end in the length direction L, and a front surface 104 and a rear surface 105 at respective ends in the width direction W. The bottom surface 102 is the surface facing the substrate 2a when the coil component 1 is mounted on the substrate 2a.

The conductor 14 includes a metal material having excellent conductivity. For example, one or more metals among Cu, Al, Ni, and Ag or an alloy containing any of these metals may be used as the metal material for the conductor 14. The conductor 14 may be a wound metal wire with an insulating film provided on the surface thereof or may be formed by plating or printing on the surface of a substrate or a sheet, for example.

The conductor 14 according to the present embodiment has a circling portion 402 with one or more turns. It is noted that the conductor 14 may have a straight or staircase-like structure without any circling portion. The shape of the circling portion 402 may be flat or spiral. The conductor 14 has extracting portions 401 for enabling external electrical conduction. The extracting portions 401 connect the external electrodes 12 to the conductor 14.

One conductor 14 may be provided for one base body 11. Alternatively, a plurality of conductors 14 may be provided for one base body 11. FIG. 3 illustrates what is generally called a horizontally wound circling portion 402 in which a wire is wound along the bottom surface 102 and top surface 101 of the base body 11. The conductor 14 may have what is generally called a vertically wound circling portion in which a wire is wound along the end surfaces 103 of the base body 11.

The coil component 1 includes the two external electrodes 12 provided on the bottom surface 1d. As one example, the external electrodes 12 are provided on the bottom surface 102 among the surfaces of the base body 11. Further, one of the external electrodes 12 is provided on the first end surface 1a side of the coil component 1 while the other is provided on the second end surface 1b side of the coil component 1. Hereinafter, in the case where the external electrodes 12 do not need to be distinguished from each other, the external electrodes 12 may collectively be referred to as the “external electrode 12.”

The external electrode 12 has a metal layer including one or more metals among Ag, Cu, Ti, Ni, and Sn. The metal layer is, for example, a layer with a thickness of 1 to 5 μm. The external electrode 12 may be a combination of a plurality of metal layers with a total thickness of 5 to 10 μm, for example. The external electrode 12 may be a combination of metal layers, part of which contains a resin, with a total thickness of 10 to 20 μm, for example.

In the example illustrated in FIG. 3, the external electrode 12 includes a base layer 201 and a plating layer 202. A metal material such as Ag, Cu, Ti, and/or Ni is used for the base layer 201. The base layer 201 is provided on the surface of the base body 11 by plating, coating of the metal material, sputtering, or vapor deposition. The base layer 201 may have a thickness of 1 μm or less, and one portion may be separated from the other portions. The base layer 201 is in close contact with the surface of the magnetic base body 11 and the extracting portion 401 of the conductor 14, so that the external electrode 12 is integrated with the base body 11 and the external electrode 12 is electrically connected to the conductor 14.

The plating layer 202 includes metal materials having excellent conductivity. For example, in addition to Cu and/or Ag, Ni, Pd, and/or Sn are also used as the metal materials. The plating layer 202 is formed in layers by superimposing layers that mainly include respective metal materials or layers that are partially alloyed.

The insulating layer 13 is provided on the top surface 101 of the base body 11 opposite to the bottom surface 102 on which the external electrode 12 is provided. In the present embodiment, the insulating layer 13 covers the entire top surface 101.

Structure of Insulating Layer

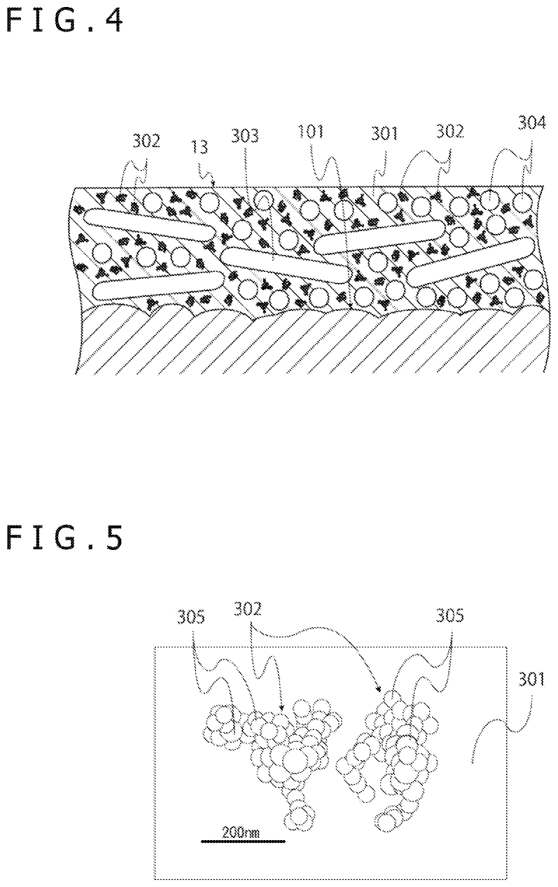

FIG. 4 is an enlarged view conceptually illustrating a microscopic structure in the insulating layer 13.

The insulating layer 13 contains a resin component 301, aggregates 302 of carbon particles, first fillers 303, and second fillers 304 and is provided on the top surface 101 of the base body 11. As the microscopic structure, the top surface 101 has an uneven structure due to the metal magnetic particles, and the insulating layer 13 is provided over the uneven structure. The surface of the insulating layer 13 has a surface roughness smaller than that of the top surface 101 of the base body 11 on which the insulating layer 13 is provided. For example, the surface roughness of the surface of the insulating layer 13 is equal to or less than half of the surface roughness of the base body 11 on which the insulating layer 13 is provided.

The insulating layer 13 has a thickness of 10 μm or less on average. The insulating layer 13 has a smaller reflectance than the top surface 101 of the base body 11 on which the insulating layer 13 is provided, and the reflectance of the insulating layer 13 is, for example, smaller than 20%. The insulating layer 13 may have a thickness of 5 μm or less on average, in which case, the reflectance of the insulating layer 13 is less than 10%.

A thermosetting resin is, for example, used as the resin component 301 of the insulating layer 13 and has, preferably, a Tg of higher than 150° C. In addition to the heat resistance, a resin with high moisture resistance, corrosion resistance, and impact resistance is selected as the resin component 301. Considering these factors, an acrylic, epoxy, or phenolic resin is preferred as the resin component 301, for example. Preferred examples of the resin component 301 include a diallyl phthalate resin, a bisphenol A epoxy resin, and a trifunctional or more multifunctional epoxy resin.

The insulating layer 13 contains the resin component 301 in an amount of higher than 30 vol % of all the elements forming the insulating layer 13. Further, two or more types of resins can be combined as the resin component 301 to meet different requirements such as the mechanical strength and the heat resistance.

The insulating layer 13 contains the aggregates 302 of the carbon particles in the resin component 301.

FIG. 5 is a view of the aggregates 302 in the resin component 301.

Carbon particles 305 in the resin component 301 form the aggregates 302 having an irregular shape. The carbon particles 305 are not single particles but a plurality of particles connected together, some of which have a chain-like length. Further, in the resin component 301, multiple aggregates 302 are connected to each other. The cross-sectional observation with a transmission electron microscope (TEM) enables confirmation of the state of these aggregates 302 by contrast differences of the carbon particles 305 where the particles overlap.

For example, carbon black or graphite is used as the carbon particles 305 forming the aggregates 302. Furnace black or acetylene black may be used as the carbon particles 305. Since the carbon particles 305 have conductivity and are also present as the aggregates 302, a portion in which electrical resistance is lower than the resin component 301 is formed in the insulating layer 13.

Even though the insulating layer 13 contains the aggregates 302 of the carbon particles 305 in the resin component 301, the insulating property is secured by the presence of the resin component 301, which has a higher insulating property than the carbon particles 305 with low conductivity, and the insulating layer 13 serves as an insulator in the normal state. Therefore, the presence of the insulating layer 13 secures the insulating property of the coil component 1. When static electricity is generated, for example, the conductivity of the carbon particles 305 suppresses charging.

It is preferable that the particle diameter of the carbon particles 305 contained in the insulating layer 13 be small. For example, the carbon particles 305 have a particle diameter of smaller than 50 nm. The carbon particles 305 may form the aggregates 302 or be dispersed in the resin component 301, and the size of each aggregate 302 is smaller than 500 nm. In the example illustrated in FIG. 5, the particle diameter of each carbon particle 305 is approximately 20 nm, and the size of each aggregate 302 is 200 to 300 nm. A plurality of aggregates 302 connected together is 400 to 3000 nm in length, for example.

The content of the carbon particles 305 in the insulating layer 13 is higher than 0.01 vol % but lower than 2 vol % of the components forming the insulating layer 13. In the case where the aggregates 302 are dispersed, the content of the carbon particles 305 may be 1 vol % or higher. In the case where the aggregates 302 are aggregated, the content of the carbon particles 305 may be lower than 1 vol %. The abundance ratio of the carbon particles 305 as viewed from the cross-section of the insulating layer is in the range of higher than 0.01% but lower than 2% as the area and can further be divided into a range of 1% or higher and a range of lower than 1%.

In the case where the content of the carbon particles 305 is 1 vol % or higher, a chain-like structure in which the aggregates 302 are further loosely connected to each other is formed, as a result of which a long-distance conductive path (percolation path) is formed. In this case, the resistance of the insulating layer 13 decreases drastically, and eddy current loss and circuit loss due to a parallel conductive path between electrodes may occur. Moreover, in the case where the content of the carbon particles 305 is 1 vol % or higher, the coating solution becomes highly viscous due to the carbon particles 305 having a high specific surface area, making it difficult to form a thin layer. On the other hand, in the case where the content of the carbon particles 305 is lower than 0.01 vol %, the insulation distance between the aggregates 302 of the carbon particles 305 becomes larger, making it difficult to form a conductive path due to static electricity and to suppress charging.

For example, in the case where the content of the carbon particles 305 is 2 vol % or higher, large aggregates of the carbon particles 305 are likely to be present, resulting in a decrease in the insulating property. For example, it is preferable that the content of the carbon particles be small, and the smaller content of the carbon particles can increase the ratio of the other components, thereby enhancing the other functions such as increasing the mechanical strength and decreasing a linear expansion coefficient. It is preferable that the insulating layer 13 have higher electrical insulation in the normal state, and the effect of electrical discharge appears when a predetermined potential difference occurs.

As illustrated in FIGS. 1 to 3, the insulating layer 13 covers the top surface 101 of the base body 11, protecting the surface of the base body 11. With this structure, the electricity charged in the coil component 1 can easily be discharged from the top surface 101, and thus the electrical effects on the base body 11 of the coil component 1 can be reduced. For example, when a metal other than the coil component 1 comes into contact with the insulating layer 13, the electric charge accumulated in the coil component 1 is discharged from the insulating layer 13 to the metal other than the coil component 1, and a voltage to be applied to the base body 11 is particularly suppressed. This, as a result, suppresses electrical breakdown that is an electrical defect caused by a current passing between the metal magnetic particles contained in the base body 11. Objects that would come into contact with the coil component 1 and accumulate electric charge are assumed to be, for example, metals or other objects with low electrical resistance and a person's finger.

In the coil component 1 using the metal magnetic particles, static electricity requires special attention. This is because static electricity is invisible and is one of the causes of defects without being noticed as abnormal. The presence of the insulating layer 13 suppresses the effect of static electricity, thereby enhancing the safety of the coil component 1.

With this structure, the coil component 1 can be transported with the insulating layer 13 serving as a contact surface. In other words, this structure can reduce damage caused by friction and vibration during transport and can, moreover, mitigate the effect on the base body 11 even if static electricity is generated by the friction caused by contact. In particular, since the insulating layer 13 covers the entire top surface 101 of the base body 11, the insulating layer 13 protects the entire top surface 101 of the base body 11, preventing defects from occurring in the insulating layer 13 and preventing electricity from being discharged from the portion other than the insulating layer 13.

Further, the insulating layer 13 has a small surface roughness. Therefore, the presence of the insulating layer 13 can suppress friction during the transport of the coil component 1 having the top surface 1c on which the insulating layer 13 is provided, facilitating the transport of the coil component 1. In addition, the insulating layer 13 suppresses charging, thereby suppressing adsorption between coil components 1 that would otherwise be caused by static electricity and facilitating the transport even if the coil component 1 is small in size.

Further, the insulating layer 13 has a small reflectance. Therefore, the presence of the insulating layer 13 makes the distinction from the base body 11 and the external electrode 12 easier, enabling, for example, directional identification using the insulating layer 13. Moreover, the insulating layer 13 having a small reflectance also facilitates visual identification of the coil component 1.

As illustrated in FIG. 4, in the present embodiment, the insulating layer 13 contains the first fillers 303 and the second fillers 304, which are inorganic fillers. In the case where the first fillers 303 do not need to be distinguished from each other, the first fillers 303 may hereinafter collectively be referred to as the “first filler 303.” Similarly, in the case where the second fillers 304 do not need to be distinguished from each other, the second fillers 304 may hereinafter collectively be referred to as the “second filler 304.”

The first filler 303 contains one or more insulating compounds among magnesium, calcium, titanium, and zirconium. Examples of the insulating compounds of the first filler 303 include magnesium silicate, calcium carbonate, titanium oxide, and zirconia. The first filler 303 has a major axis and a minor axis as its outer shape. Specifically, the first filler 303 may have a flat, elliptical, plate-like, or needle-like outer shape, for example.

The second filler 304 contains one or more insulating compounds among silicon, aluminum, and magnesium. Examples of the insulating compounds of the second filler 304 include silicon dioxide, aluminum oxide, and magnesium oxide. Further, the second filler 304 has a spherical outer shape.

The first filler 303 is larger than the second filler 304. For example, the major axis of the first filler 303 is larger than the particle diameter of the second filler 304, while the minor axis of the first filler 303 is larger than the particle diameter of the second filler 304. The first filler 303 has a major axis of 1 to 10 μm and a minor axis of 100 nm to 1 μm. The second filler 304 has a major axis of 50 to 500 nm and a minor axis larger than 80% of the major axis. The abundance ratio of the second filler 304 is larger than that of the first filler 303. The combined abundance ratio of the first filler 303 and the second filler 304 is 30 to 50 vol % of the insulating layer 13. For example, the combined abundance ratio of the first filler 303 and the second filler 304 is smaller than the abundance ratio of the resin component 301. Adjusting the combination of the sizes of the inorganic fillers 303 and 304 can secure the desired functions and reduce the thickness of the insulating layer 13. Moreover, the presence of the first filler 303 ensures shape stability at edges or other portions of the insulating layer 13, while the presence of the second filler 304 improves the dispersion state in the insulating layer 13, reducing the thickness of the insulating layer 13. In the case where the inorganic fillers 303 and 304 are light-transmissive fillers such as silica, the inorganic fillers 303 and 304 viewed in the thickness direction of the insulating layer 13 are 100 to 300 nm in size. The inorganic fillers 303 and 304 can provide the light-shielding property and suppress light transmission and reflection. Therefore, even though the thickness of the insulating layer 13 is small, the base body 11 is not visible therethrough.

Since the insulating layer 13 contains the inorganic fillers 303 and 304, the insulating property can be enhanced in the normal state in which no static electricity exists. This means that the insulating layer 13 provides high insulation in the normal usage of the coil component 1 and serves as an insulator in the range of voltages lower than 100 V, for example. Expressed in terms of the magnitude of the resistance of each element, when the voltage is lower than 100 V, the conductor<the base body the insulating layer, while, when the voltage is higher than 100,000 V, the conductor<the insulating layer<the base body.

The presence of the inorganic fillers 303 and 304 in the insulating layer 13 contributes to lowering the linear expansion coefficient. Further, the inclusion of the two types of inorganic fillers, that is, the first filler 303 and the second filler 304, increases the uniformity of the inorganic fillers due to their dispersiveness, thereby increasing the mechanical strength. In particular, the inclusion of the first filler 303 reduces the linear expansion coefficient in the direction parallel to the surface of the insulating layer 13.

Each element contained in the insulating layer 13 can be confirmed by observing the cross-section of the insulating layer 13 with, for example, a TEM, a scanning electron microscope (SEM), or an optical microscope. The presence of the carbon particles 305, the inorganic fillers 303 and 304, and voids is determined from the difference in contrast in the optical observation of the cross-section of the insulating layer 13. Similarly, the presence and sizes of the fillers can also be determined by viewing the cross-section of the insulating layer 13. The resin component 301 is the portion excluding the carbon particles 305, the inorganic fillers 303 and 304, and voids, and the abundance ratio of the resin component 301 is determined accordingly.

### Method of Manufacturing Coil Component

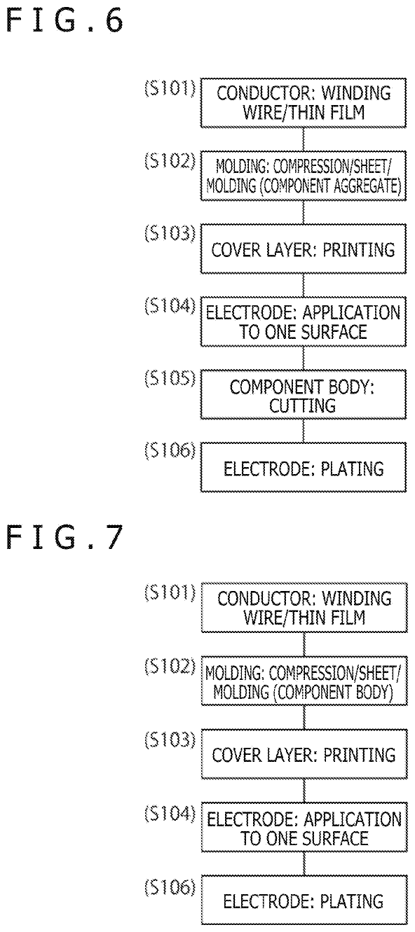

FIG. 6 is a flowchart illustrating an example of a method of manufacturing the coil component 1.

At step S101, the conductor 14 is formed. The conductor 14 may be formed by winding a metal wire or by plating or printing on the surface of a substrate or a sheet, for example.

At step S102, the base body 11 is formed with the conductor 14 inside. It is noted that, in the manufacturing method illustrated in FIG. 6, the base body 11 is formed as a component aggregate in which a plurality of base bodies 11 are connected to each other. In the case of the coil component 1 of a metal composite type, for example, the base body 11 is molded to a molded body by applying pressure and temperature to a composite magnetic material containing metal magnetic particles and a resin. In this molding stage, the conductor 14 is integrated with the base body 11.

Specifically, in the molding, the pressure is, for example, 10 to 100 MPa and the temperature is, for example, 100° C. to 200° C. The molded body is heated to 150° C. to 200° C. to advance the curing of the resin of the composite magnetic material, thereby becoming the base body 11 as the magnetic body.

The base body 11 may be molded by laminating sheet-like magnetic materials or by molding.

At step S103, a resin material containing the carbon particles 305 is applied to one surface corresponding to the top surface 101 of the base body 11 among the surfaces of the molded body, and the resin is cured to form the insulating layer 13. The resin material is applied by printing, for example, and is applied over the entire surface of the above-described one surface. As a result, the insulating layer 13 covering the entire top surface 101 of the base body 11 is formed.

Although the resin material can be applied by printing, dipping, impregnation, or other methods, printing is a preferable method in order to make the insulating layer 13 thinner or meet the requirement of positional accuracy of the insulating layer 13. When the resin material is applied by printing, the resin material is applied in such a manner as to fill the recesses of the unevenness on the surface of the molded body that becomes the base body 11 and absorb the unevenness, so that the insulating layer 13 itself can be made thinner. Further, printing is also a preferable method in order to reduce the surface roughness of the surface of the insulating layer 13. In the case where a resin is contained in the base body 11, a resin with a Tg higher than the Tg of the resin forming the insulating layer 13 is contained in the base body 11, so that the deterioration of the resin can be suppressed during the manufacturing process.

At step S104, a metal material is applied to the bottom surface of the molded body by, for example, screen printing, transfer, or dipping, so that the base layer 201 of the external electrode 12 is formed.

At step S105, the component aggregate is cut into individual components.

At step S106, plating is performed on the individual components, so that the plating layer 202 of the external electrode 12 is formed.

For example, in this manufacturing method, since the insulating layer 13 is formed at the stage of the component aggregate, the thickness of the insulating layer 13 of each coil component can be formed uniformly.

FIG. 7 is a flowchart illustrating another example of the method of manufacturing the coil component 1.

In this example of the manufacturing method, steps S101 to S104 are performed in a manner similar to the one described above. However, whereas the component aggregate is molded at step S102 in the above-described example, step S105 does not exist in the example illustrated in FIG. 7 because the base body 11 is molded as an individual component.

Therefore, in the example of FIG. 7, after the base layer 201 of the external electrode 12 is formed at step S104, the process proceeds to step S106 at which the plating layer 202 of the external electrode 12 is formed.

For example, in this manufacturing method, the insulating layer 13 can selectively be provided on part of the top surface 101 of the base body 11.

The coil component 1 is manufactured by the manufacturing method described above.

### Second Embodiment

A second embodiment of the present disclosure is described below. It is noted that the description focuses on differences from the first embodiment and redundant description is omitted.

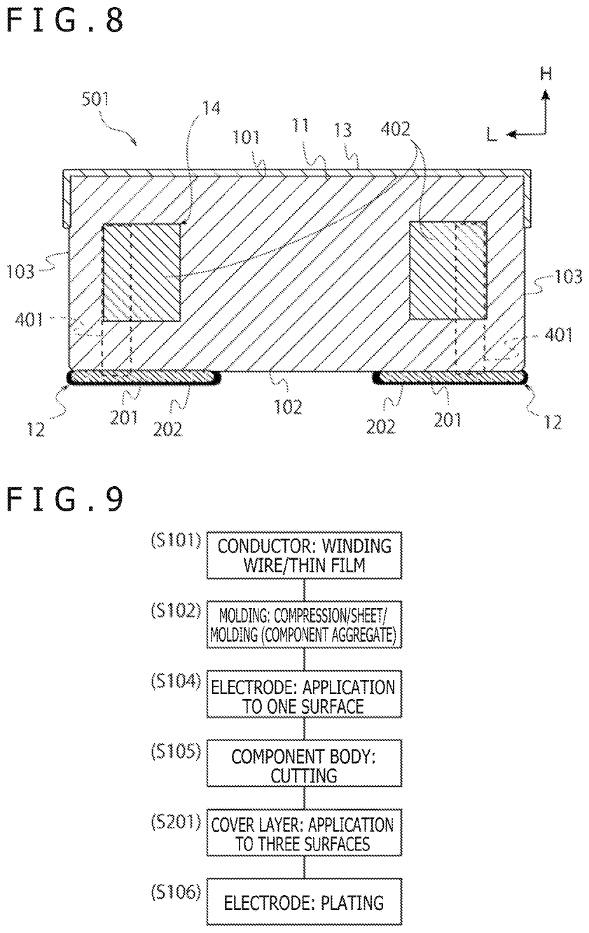

FIG. 8 is a cross-sectional view of a coil component 501 according to the second embodiment.

In the coil component 501 according to the second embodiment, the insulating layer 13 is provided from the top surface 101 to the end surfaces 103 adjacent to the top surface 101. The insulating layer 13 may extend to the front surface 104 and rear surface 105 adjacent to the top surface 101.

In the second embodiment, the electrical path is wider than the electrical path in the first embodiment because the insulating layer 13 is provided on the surfaces in addition to the top surface 101. Therefore, in the second embodiment, static electricity is more easily dissipated and higher safety is achieved than in the first embodiment.

Further, in the second embodiment, since the insulating layer 13 covers the surface of the base body 11 over a wider region than the first embodiment, the surface of the base body 11 is more protected. In particular, this structure prevents damage to the ridges, which are vulnerable to loads such as weighting and impact, and prevents, for example, removal of the metal magnetic material and degradation of insulation due to the removal of the particles.

FIG. 9 is a flowchart illustrating a method of manufacturing the coil component 501 according to the second embodiment.

In the method of manufacturing the coil component 501 according to the second embodiment, steps S101, S102, S104, and S105 are also performed as with the manufacturing method illustrated in FIG. 6. In the second embodiment, step S103 is not performed. Further, in the second embodiment, step S201 is performed after step S105.

At step S201, a resin material containing the carbon particles 305 is applied to a total of three surfaces, i.e., the top surface 101 and the end surfaces 103, of the molded body cut into an individual component, and the resin is cured to form the insulating layer 13.

After that, the process proceeds to step S106 at which the plating layer 202 of the external electrode 12 is formed. In the second embodiment, components may be formed individually as with the example of FIG. 7.

For example, in this manufacturing method, the insulating layer 13 can be provided on a plurality of surfaces of the coil component. Further, combining a plurality of application methods can make it easier to differentiate the thicknesses of the surfaces.

### Third Embodiment

A third embodiment of the present disclosure is described below. It is noted that the description focuses on differences from the first embodiment and redundant description is omitted.

FIG. 10 is a cross-sectional view of a coil component 502 according to the third embodiment.

In the coil component 502 according to the third embodiment, the insulating layer 13 is provided on all six surfaces, i.e., the top surface 101, the bottom surface 102, the end surfaces 103, the front surface 104, and the rear surface 105. It is noted that the insulating layer 13 is provided on a portion other than the external electrode 12 on the bottom surface 102.

In the third embodiment, since the insulating layer 13 is provided in contact with the external electrode 12, electric charge such as static electricity flows into the external electrode 12 and is quickly dissipated. Therefore, the safety of the coil component 502 according to the third embodiment against static electricity is higher than that of the coil components according to the first and second embodiments. In addition, since the insulating layer 13 covers almost the entire base body 11, all the surfaces of the base body 11 are protected. Further, the insulating layer 13 provided on the surface where the conductor 14 and the external electrode 12 are connected to each other is the thickest. This structure prevents defects from occurring in the insulating layer 13 around the portion where the conductor 14 and the external electrode 12 are connected to each other.

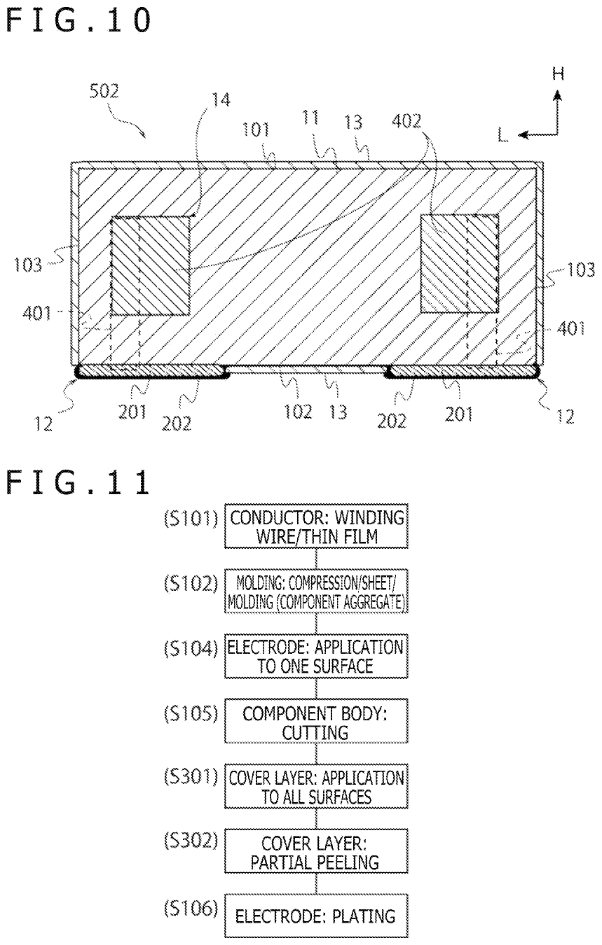

FIG. 11 is a flowchart illustrating a method of manufacturing the coil component 502 according to the third embodiment.

In the method of manufacturing the coil component 502 according to the third embodiment, steps S101, S102, S104, and S105 are performed as with the manufacturing method illustrated in FIG. 6. In the third embodiment, step S301 is performed after step S105.

At step S301, a resin material containing the carbon particles 305 is applied to all the six surfaces of the molded body cut into an individual component, and the resin is cured to form the insulating layer 13. At step S302, a portion of the insulating layer 13 formed on the base layer 201 of the external electrode 12 at step S301 is peeled off.

After that, the process proceeds to step S106 at which the plating layer 202 of the external electrode 12 is formed on the base layer 201. In the third embodiment, components may be formed individually as with the example of FIG. 7.

For example, in this manufacturing method, the peeling of the resin material to expose the base layer 201 of the external electrode 12 may also be performed in portions other than the base layer 201, so that the thickness of the insulating layer 13 can be adjusted.

### Fourth Embodiment

A fourth embodiment of the present disclosure is described below. It is noted that the description focuses on differences from the third embodiment and redundant description is omitted.

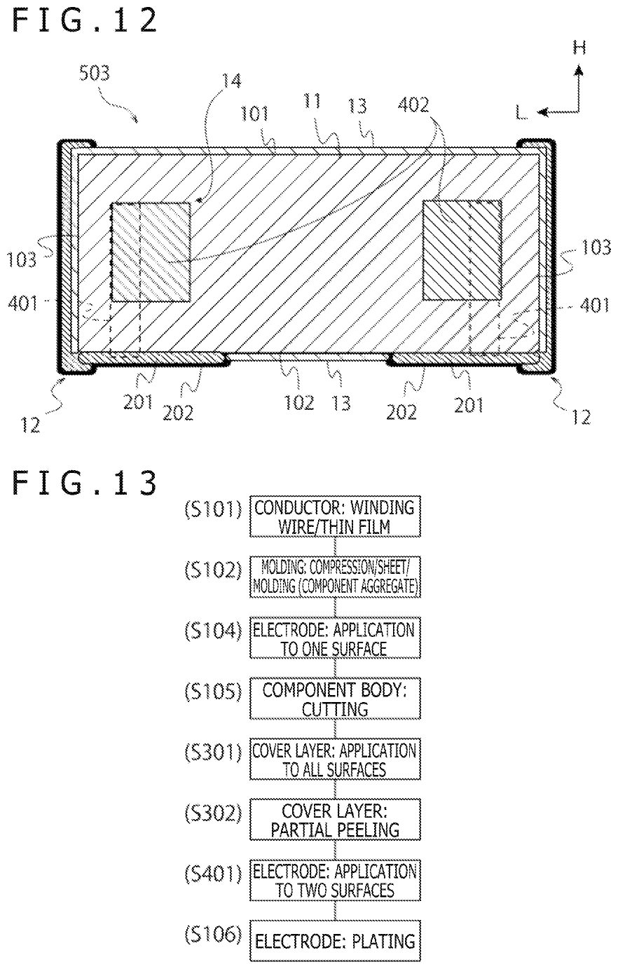

FIG. 12 is a cross-sectional view of a coil component 503 according to the fourth embodiment.

The coil component 503 according to the fourth embodiment includes the external electrode 12 extending from the bottom surface 102 and partially reaching the top surface 101 via the end surfaces 103. A portion of the external electrode 12 extending along the end surfaces 103 and the top surface 101 is provided on the insulating layer 13.

In the fourth embodiment, since the insulating layer 13 and the external electrode 12 are in contact with each other over a large area, electric charge such as static electricity flows into the external electrode 12 even more quickly than in the third embodiment and is dissipated quickly. Therefore, the safety of the coil component 503 according to the fourth embodiment against static electricity is higher than that of the coil components according to the first to third embodiments. Further, the external electrode 12 reaching the end surfaces 103 and the top surface 101 also serves to protect the coil component 503.

FIG. 13 is a flowchart illustrating a method of manufacturing the coil component 503 according to the fourth embodiment.

In the method of manufacturing the coil component 503 according to the fourth embodiment, steps S101, S102, S104, and S105 are performed as with the manufacturing method illustrated in FIG. 6. After that, steps S301 and S302 are performed as with the manufacturing method according to the third embodiment. In the fourth embodiment, step S401 is performed after step S302.

At step S401 of FIG. 13, a metal material is applied to the insulating layer 13 formed on the end surfaces 103 and top surface 101 of the molded body, by screen printing, transfer, or dipping to form the base layer 201 of the external electrode 12. The base layer 201 formed at step S401 partially reaches the bottom surface 102 and is connected to the base layer 201 already formed on the bottom surface 102.

After that, the process proceeds to step S106 at which the plating layer 202 of the external electrode 12 is formed on the base layer 201 extending from the bottom surface 102 to the top surface 101 via the end surfaces 103. In the fourth embodiment, components may be formed individually as with the example of FIG. 7. At step S301, the insulating layer 13 may be formed only on the top surface 101 of the base body 11 among the surfaces of the molded body. This is because only the insulating layer 13 and the external electrode 12 need to be in contact with each other and in this way the base body 11 can be maximized.

### Fifth Embodiment

A fifth embodiment of the present disclosure is described below. It is noted that the description focuses on differences from the first embodiment and redundant description is omitted.

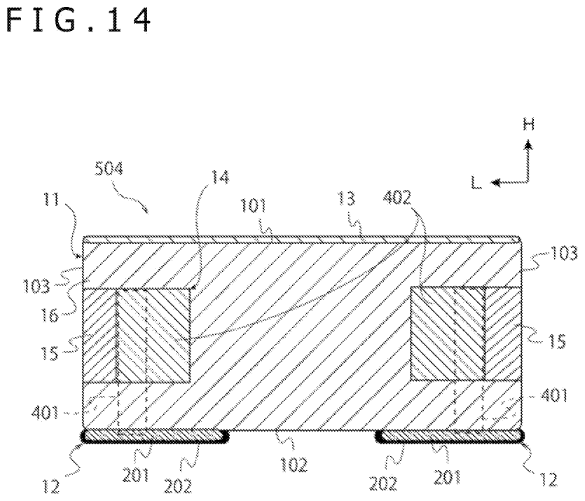

FIG. 14 is a cross-sectional view of a coil component 504 according to the fifth embodiment.

In the coil component 504 according to the fifth embodiment, the base body 11 is a combination of a T-core or drum-core magnetic body 16 and an outer body 15. The magnetic body 16 has a brim and shaft around which the conductor 14 is wound on the surface. The outer body 15 covers the outer side of the conductor 14. The insulating layer 13 is provided on the top surface 101 as with the first embodiment.

The insulating layer 13 may be provided only on the surface of the magnetic body 16, on both of the surfaces of the magnetic body 16 and the outer body 15, or only on the surface of the outer body 15. In any of these cases, the effect of the insulating layer 13 described in the first to fourth embodiments can be obtained.

The method of manufacturing the coil component 504 according to the fifth embodiment can be similar to the method of manufacturing the coil component 1 according to the first embodiment. Further, the method of manufacturing the coil component 504 according to the fifth embodiment may be different from the method of manufacturing the coil component 1 according to the first embodiment in that steps S102 and S101 are performed in this order.

The manufacturing methods according to the first to fifth embodiments are not limited to the above-described examples, and the order of execution of each step described above can be changed to any order to the extent that structural inconsistencies do not occur.

What is claimed is:

1. A coil component comprising:
a base body having a magnetic body portion containing a metal magnetic material;
a conductor provided inside the base body;
an insulating layer that is provided on a surface of the magnetic body portion in the base body and that is a resin containing carbon particles; and
an external electrode that extends along the surface of the base body and that is connected to the conductor.

2. The coil component according to claim 1, wherein the insulating layer contains the carbon particles in an amount of higher than 0.01 vol %.

3. The coil component according to claim 1, wherein the insulating layer contains an insulating inorganic filler.

4. The coil component according to claim 3, wherein the insulating layer contains, as the inorganic filler, a first inorganic filler having a major axis and a minor axis.

5. The coil component according to claim 3, wherein the insulating layer contains, as the inorganic filler, a second inorganic filler having a spherical shape.

6. The coil component according to claim 1, wherein the resin has a glass transition temperature of higher than 150° C.

7. The coil component according to claim 1,
wherein the base body has a first surface and a second surface opposite to the first surface,
the insulating layer is provided on the first surface, and
the external electrode is provided on the second surface.

8. The coil component according to claim 7, wherein the insulating layer covers the entire first surface.

9. The coil component according to claim 7, wherein the insulating layer extends from the first surface to a surface adjacent to the first surface.

10. The coil component according to claim 7, wherein the external electrode extends from the second surface to a surface adjacent to the second surface.

11. The coil component according to claim 1, wherein the insulating layer has a thickness of less than 10 μm.
